(19) United States
(12) Patent Application Publication
(10) Pub. No.: US 2021/0398204 A1
(43) Pub. Date: Dec. 23, 2021

(54) Formation of a Financial Life Story

(71) Applicant: Wells Fargo Bank, N.A., San Francisco, CA (US)

(72) Inventors: Anita Sukur, Minneapolis, MN (US); Barry Lozier, San Francisco, CA (US); Nikolai Stroke, Gilbert, AZ (US); Steven Spencer Putney, San Francisco, CA (US); Stephanie Warburton, San Francisco, CA (US)

(21) Appl. No.: 15/788,982

(22) Filed: Oct. 20, 2017

Related U.S. Application Data
(60) Provisional application No. 62/413,657, filed on Oct. 27, 2016.

(51) Int. Cl. G06Q 40/00

(52) U.S. Cl. CPC G06Q 40/00

(57) ABSTRACT

A method implemented on an electronic computing device for creating a financial story for an individual includes receiving information regarding finances for the individual, obtaining information comprising biographical information for the individual and obtaining information regarding future goals for the individual. The received and obtained information is used to create the financial story for the individual. The financial story includes a timeline that shows past and future life and financial events for the individual. At least some of the future life and financial events for the individual on the timeline are automatically generated using heuristics.

### BACKGROUND

Financial institutions, financial advisors and others commonly recommend that individuals engage in some form of financial planning. The financial planning can typically include aspects such as planning to purchase a home, planning for college for one's children and planning for retirement.

The development of a financial plan for an individual can include many factors, including the age of the individual, members and age of the individual's family, current employer and salary of family members, whether the individual owns or rents and other factors. Changes to one or more of these factors can have an impact on the development of the financial plan.

### SUMMARY

Embodiments of the disclosure are directed to a method implemented on an electronic computing device for creating a financial story for an individual, the method comprising: on the electronic computing device, receiving first information regarding finances for the individual; obtaining second information comprising biographical information for the individual; obtaining third information regarding future goals for the individual; and using the first information, the second information and the third information to create the financial story for the individual, the financial story comprising a timeline that shows past and future life and financial events for the individual, wherein at least some of the future life and financial events for the individual on the timeline are automatically generated using heuristics.

In another aspect an electronic computing device comprises: a processing unit; and system memory, the system memory including instructions which, when executed by the processing unit, cause the electronic computing device to: obtain first information regarding finances for an individual; obtain second information comprising biographical information for the individual; obtain third information regarding future goals for the individual; obtain fourth information regarding financial transactions and life events for one or more additional individuals similar to the individual; and use the first information, the second information, the third information and the fourth information to create an interactive timeline for the individual, the interactive timeline showing past and future life and financial events for the individual, wherein at least some of the future life and financial events for the individual on the timeline are automatically generated using heuristics.

In yet another aspect, an electronic computing device comprises: a processing unit; and system memory, the system memory including instructions which, when executed by the processing unit, cause the electronic computing device to: obtain first information regarding finances for an individual; obtain second information comprising biographical information for the individual; obtain third information regarding future goals for the individual; obtain fourth information regarding financial transactions and life events for one or more additional individuals similar to the individual; use the first information, the second information, the third information and the fourth information to create an interactive timeline for the individual, the interactive timeline showing past and future life and financial events for the individual; receive a first request to add an additional event to the interactive timeline; as a result of the first request: add the additional event to the interactive timeline; and adjust the time of one or more existing events based on the adjustment of the position of the existing event, wherein, at least some of the future life and financial events are based on life events for one or more of the additional individuals similar to the individual.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports an interactive timeline of a financial story for an individual.

FIG. 2 shows an example timeline for a financial story of a customer of a financial institution associated with the financial institution server computer of FIG. 1.

FIG. 3 shows an example text than can be displayed when zooming in or selecting an event of the timeline of FIG. 2.

FIG. 4 shows another example timeline for a financial story of a customer of a financial institution associated with the financial institution server computer of FIG. 1.

FIG. 5 shows an example timeline for a financial story that includes a branch.

FIG. 6 shows an example of a timeline for a financial story that is merged from related timelines.

FIG. 7 shows a method for creating an interactive timeline for a financial story.

FIG. 8 shows example physical components of the electronic computing devices of FIG. 1.

### DETAILED DESCRIPTION

The present disclosure is directed to the formation of a financial life story for an individual. The financial life story can be compiled by a financial institution and displayed graphically via a timeline on an electronic computing device. The financial institution can leverage existing data the financial institution already has about the individual, such as biographical information (for example age, marital status, information about the individual's children), previous and existing loans, checking and savings account information and credit card accounts. The financial institution can also leverage information provided by the individual regarding prior and/or possible future events, such as the purchase of a home, college and retirement.

The timeline can include known events regarding the individual and the individual's family, life goals for the individual and plans for the individual. The timeline can also include proposed goals for the individual, based on information known about the individual and based on goals for similar individuals. In this disclosure, the individual is described as being a customer of the financial institution, although the individual need not be a customer in some implementations. In this disclosure, the terms customer and individual are used interchangeably.

Using the systems and methods, the timeline can be interactive. The individual can add, remove, and adjust events on the timeline. The timeline can also facilitate experimentation. The individual can add or adjust alternative events and view expected outcomes on the timeline based on the added or adjusted alternative events. For example, the individual can add an event corresponding to purchasing a home and observe the effect on other events on the timeline. The individual can compare timeline events to an alternative of renting an apartment instead of purchasing a home. The timeline can also be merged with timelines for related financial stories, such as those from husband/wife and/or children.

Future events can be automatically added to the timeline based upon heuristics specific to the individual. The heuristics can be based on guidance by team members of the financial institution and a knowledge base with knowledge specific to the individual. For example, when the financial institution has a personal profile of the individual and a determination is made that the individual has children of a certain age, the financial institution can add a proposed goal to the timeline of saving money for college for the children at an appropriate point in the timeline. The appropriate point can be similar to a timeline point when individuals of a similar background to the individual start saving for college for their children. As another example, the financial institution can project that based on the profile of the individual, a financial status of the individual and information for the individuals of the similar background, a proposed goal of purchasing a home and acquiring a mortgage can be added at an appropriate point in the timeline. Other examples are possible.

The financial institution can aggregate data across customer populations to identify trends across customer populations and to apply those trends to similar individuals. The financial institution can also use marketing data from third party sources, for example Forrester, JD Power or Zillow to determine trends. For example, the aggregated data may suggest that a person with the individual's socioeconomic background may be likely to purchase a boat at some time in the future. Based on the aggregated data, the financial institution may suggest a goal of purchasing a boat and saving for the boat over a period of time, for example 10 years. The financial institution may also suggest events such as budgeting for maintenance of the boat.

As discussed in more detail later herein, the timeline can be built using event blocks that can be assembled automatically and/or with customer input. The event blocks can allow the customer to view events both forward and backward in time. The event blocks can be shaded or colored to provide a status. For example, in one implementation, event blocks can be a solid color for past events that have already occurred and a faded color or a non-solid pattern for predicted events that have not yet occurred. The event blocks in the faded color or non-solid pattern can change to the solid color when the event does occur.

The timeline can also display financial information at various points on the timeline. For example, by selecting a point on the timeline (for example by tapping the timeline), the customer can display financial information such as net worth, assets, liabilities, retirement savings and significant property owned. Other information can be displayed on the timeline.

In addition, a feed can be provided to a storyline in which the storyline can be exposed in various contexts, such as on a mobile device and on a website. The feed can include actual events, assumed events (e.g. events suggested by the financial institution), individual goals, a narrative that can include emotional information and a journal.

The systems and methods disclosed herein are directed to a computer technology that can automatically generate an interactive timeline corresponding to an individual's life story and that can permit the individual to view how financial decisions can impact his/her financial health. Future events can be added to the timeline based on heuristics, leveraging financial and profile information already known about the individual and aggregated data from other individuals with backgrounds similar to the individual. The technology permits the individual to manually add goals and events and to manually and visually move goals and events and to automatically view a financial impact of any changes.

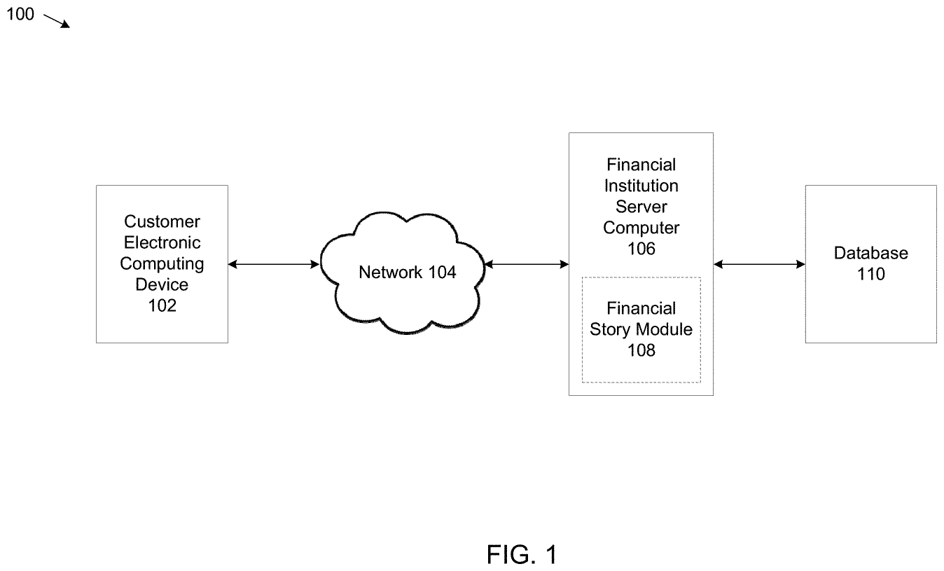

FIG. 1 shows an example system 100 that can support an interactive timeline of a financial life story for an individual who is a customer of a financial institution, such as a bank. The system 100 includes a customer electronic computing device 102, a network 104, a financial institution server computer 106 and a database 110. The financial institution server computer 106 includes a financial story module 108. More, fewer or different modules can be used.

The example customer electronic computing device 102 is an electronic computing device of the customer. The electronic computing device can be a desktop computer, a laptop computer, a mobile electronic computing device such as a smartphone or a tablet computer. The electronic computing device permits the customer to access the financial institution server computer 106 over network 104.

The example network 104 is a computer network, such as the Internet. A customer on customer electronic computing device 102 can access financial institution server computer 106 via network 104.

The example financial institution server computer 106 is a server computer of a financial institution, such as a bank. The customer can have one or more financial accounts at the financial institution. In addition, the financial institution server computer 106 can have access to a personal profile for the customer and can have access to a history of financial transactions made by the customer at the financial institution. In some implementations, the financial institution server computer 106 can comprise a plurality of server computers.

The example financial story module 108 can implement an interactive timeline that depicts a financial life story for the customer. As discussed in more detail later herein, the financial story module 108 can provide event descriptors on the timeline that can identify events that have already occurred, future events planned by the customer, future goals of the customer and proposed events based on a heuristic evaluation of the customer and of individuals with backgrounds similar to the customer. The financial story module 108 can also implement an interactive aspect of the timeline in which the customer can add and remove events and move events on the timeline and in which outcomes of these actions can be identified and displayed. The financial story module 108 can also implement other aspects of the timeline, as discussed later herein.

The example database 110 is an electronic database that can store financial records for the individual and for family members of the individuals. The database 110 can be accessed by financial institution server computer 106.

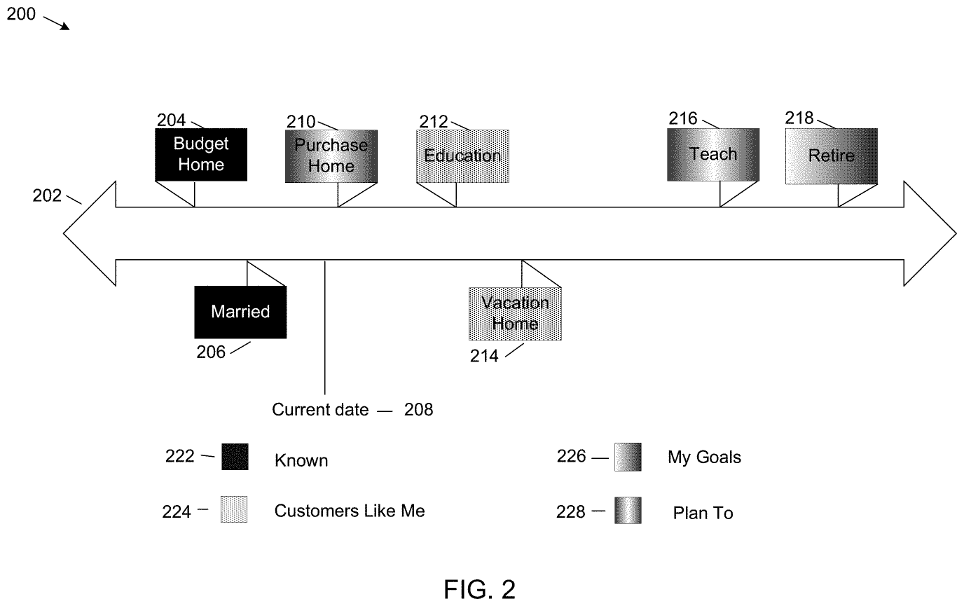

FIG. 2 shows an example timeline 200 for a storyline of the customer of the financial institution. The timeline 200 includes a timeline base 202 from which events can be attached. The timeline base 202 implements a timeline with earlier dates at a left end of the timeline base 202 and later dates towards a right end of the timeline base 202.

The example timeline 200 includes four types of events. A first event type 222 comprises events already known to have occurred. Each event of first event type 222 is shown in a solid color. A second event type 224 comprises events projected by heuristics as possible events for the customer. Each event of second event type 224 comprises an event that can typically occur for individuals with backgrounds similar to the customer. Each event of second event type 224 is shown in the specific shading indicated for the second event type 224 on FIG. 2. A third event type 226 comprises personal goals for the customer. The customer can enter the personal goals from a toolbar (not shown) that can be part of a user interface for timeline 200. Each event of third event type 226 is shown in the specific shading indicated for the third event type 226 on FIG. 2. A fourth event type 228 comprises events that the customer has plans to do, for example purchasing a home. Each event of fourth event type 228 is shown in the specific shading indicated for the fourth event type 228 in FIG. 2. When each event that is not already completed is completed, the financial story module 108 can change the shading for the event to the solid color of event type 222.

As shown in the example timeline 200, a first event shown on the timeline 200 is a budget home event 204. Because the budget home event 204 is shown in a solid color, the budget home event 204 is known to have already occurred. The budget home event 204 represents the customer creating a budget to purchase a home.

A second event, shown next in chronological order on timeline 200, is a married event 206. The married event 206, corresponding to the customer getting married is also known to have already occurred. Next chronologically on the timeline 200 is an indication of a current date 208 in relation to other events on the timeline 200.

A third event, shown next in chronological order on timeline 200, is a purchase home event 210. The purchase home event 210 is of the event type 228, indicating that the customer has not yet purchased a home but plans to do so.

A fourth event, shown next in chronological order on timeline 200, is an education event 212. The education event 212 is of the event type 224, indicating that individuals with backgrounds similar to the customer (customers like me) typically start savings for college for their children at approximately the time shown in timeline 200. The time for the education event 212 is determined by heuristics based on a known age of the customer's children. The ages of the customer's children can be determined from a profile or other information for the customer accessible on or from financial institution server computer 106.

A fifth event, shown next in chronological order on timeline 200, is a vacation home event 214. The vacation home event 214 is also of event type 224, indicating that individuals with backgrounds similar to the customer often purchase vacation homes at approximately the time shown in timeline 200. The time of the vacation home event 214 can be based on several factors, including the age of the customer, the age of the customer's children and an amount of financial assets, including current income, for the customer. The vacation home event 214 is shown as a goal for the customer.

A sixth event, shown next in chronological order on timeline 200, is a teach event 216. The teach event 216 is of event type 228, indicating the teach event 216 is something that the customer plans to do. In this case, the customer plans to teach at a high school at a later stage of the customer's career.

A seventh event, shown next in chronological order on timeline 200, is a retire event 218. The retire event 218 is of event type 226, indicating that it is a personal goal of the customer to retire at the time shown on timeline 200.

As shown in FIG. 2, the timeline 200 does not show any specific dates for any of the events displayed. However, in an actual implementation, the timeline 200 would show specific dates for each event. The events shown in FIG. 2 are shown in an approximate time relation to each other.

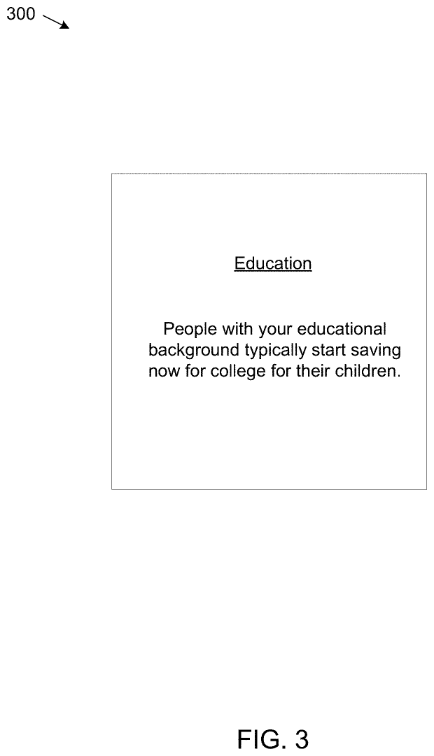

The timeline 200 also permits the customer to zoom in on an event and view more detailed information regarding the event. FIG. 3 shows an example of detailed information that can be displayed when zooming in or selecting the education event 212. As shown in FIG. 3, an example message 300 is displayed when the education event 212 is selected. The example message 300 indicates that people with an educational background similar to the customer typically start saving for college for their children at the point in timeline 200 indicated by the placement of the education event 212. The financial story module 108 can base this message on such factors as the age of the customer's children, the age of the customer and his spouse and the financial health of the customer. Other factors are possible. Other messages are possible.

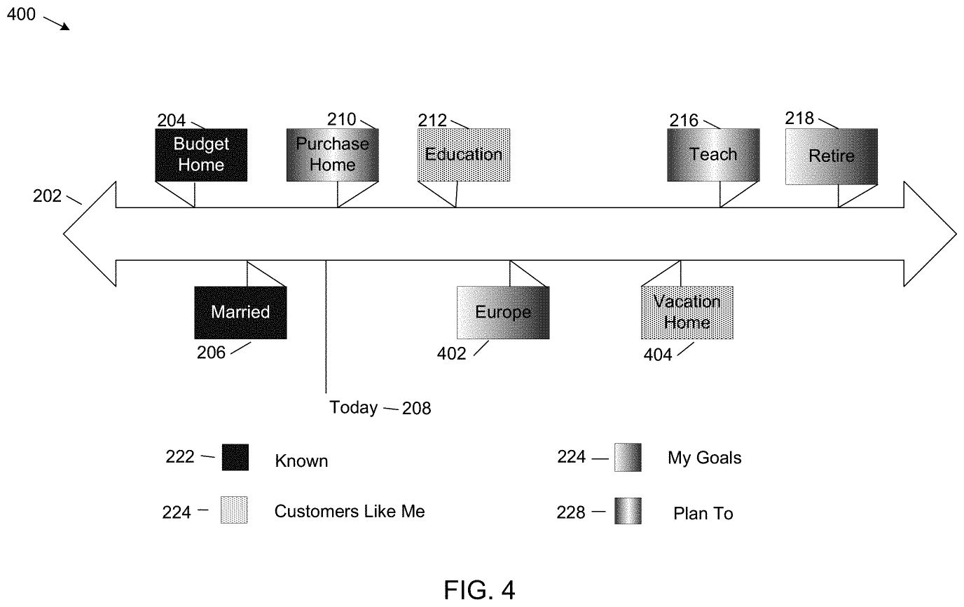

FIG. 4 shows how the example timeline 200 of FIG. 2 can change based on customer interactions with timeline 200. The example timeline 400 of FIG. 4 shows a change based on a customer personal goal of a European vacation. The customer can add the European vacation by selecting an event for a personal goal (event type 224) from a toolbar (not shown in FIG. 4), labeling the event as Europe, dragging the event to the timeline 200 and positioning the event as the Europe event 402 on the timeline 200. As a result of adding the Europe event 402, the financial story module 108 can determine that, based on an analysis of the customer's finances and expenses, in order for the customer to be able to afford the European vacation, the customer's goal of purchasing a vacation home should be postponed to a future date. Therefore, the financial story module 108 can automatically move the vacation home event 214 to a later date, as shown by the positon of the vacation home event 404 on FIG. 4. The financial story module 108 can also determine that none of the other events from FIG. 2 need to change in order for the customer to afford the European vacation.

In a similar manner to the addition of the European vacation in FIG. 4, the customer can experiment with a variety of other life story scenarios. For example, the customer can experiment with delaying the purchase home event 210 by moving the purchase home event 210 to a different time on timeline 200. For each point on timeline 200 that the customer positions the purchase home event 210, the financial story module 108 can adjust the existing events on timeline 200 or add other events based on heuristics. For example, based on the customer's interests and an analysis of the customer's finances, the financial story module 108 can add an event for purchasing a boat. Alternatively, or in addition, the financial story module 108 can move up the time at which the customer can retire or purchase the vacation home.

In some implementations, as stated earlier herein, the financial story module 108 can show different branches with differing scenarios. For example, the financial story module 108 can show one branch with events occurring when the customer purchases the home at position A in the timeline, another branch when the customer purchases the home at position B in the timeline and a third branch when the customer does not purchase a home and decides to rent instead. As another example, the financial story module 108 can show one branch for a fixed rate mortgage and other branch for a variable rate mortgage. Other scenarios are possible.

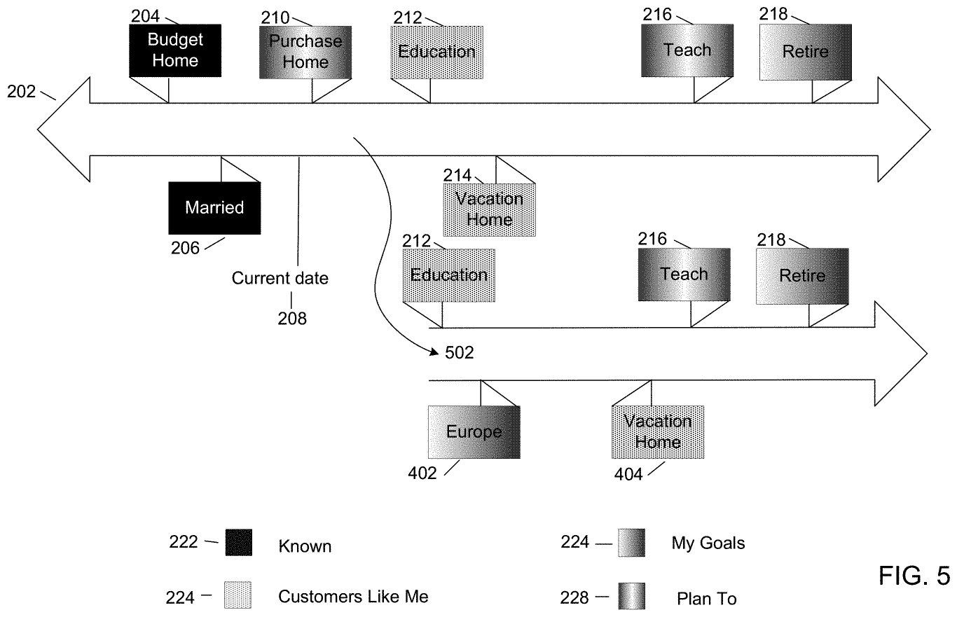

FIG. 5 shows an example of a branch 502 of the timeline 202 based on the changes described above regarding the European vacation. As shown in FIG. 5, the branch 502 of the timeline 202 shows a portion of the timeline 202 that changes (including events 402 and 404) and also displays the timeline 202 from FIG. 2 to provide a comparison of events. By viewing the branch 502, the individual can more easily see a comparison of events based on changes to the timeline 202. For example, the individual can see how the vacation home event 404 has moved out in the future (in comparison with the original vacation home event 214) as a result of adding the European vacation.

In other implementations, the branch 502 may be implemented differently. For example, a portion of the timeline 202 up a point of time of the branch 502 may be centered with previous events (212, 214, 216 and 218) shown above the centered timeline 202 and events that occur based on the branch 502 (402, 404 and events 212, 216 and 218 that do not change based on the branch 502) shown below the centered timeline 202. Other presentations are possible.

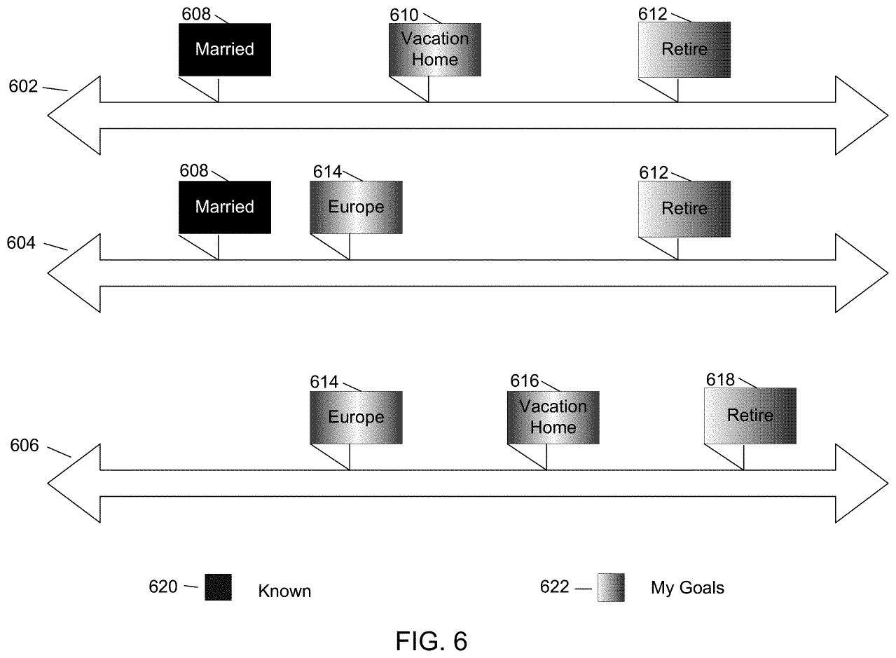

FIG. 6 shows an example of how two related timelines can be merged. Included in FIG. 6 are timelines 602, 604 and 606. Timeline 602 represents a financial story for a customer of a financial institution, timeline 604 represents a financial story for the wife of the customer and timeline 606 represents a merger of timeline 602 and 604. For this example, two types of events are shown, a known event, corresponding to solid color 620 and a goal event, corresponding to a shading pattern 622.

Timeline 602 for the customer shows a known event of married 608, a goal event of purchasing a vacation home 610 and a goal event of retirement 612. Timeline 604 for the wife shows a known event of married 608, a goal event of a European vacation 614 and a goal event of retire 612. Because the customer and wife are married, the known event of married 608 is the same event on both timeline 602 and timeline 604. In addition, because the individual and his wife plan to retire at the same time, the goal event of retire 612 is also the same event on both timeline 602 and timeline 604.

When timeline 602 and timeline 604 are merged, the financial story module 108 analyzes events for timelines 602 and 604 and other information such as the financial health of the customer and his wife and determines whether and how events from timelines 602 and 604 can be combined. For the example shown in FIG. 6, the financial story module 108 determines that in order to merge timeline 602 with timeline 604 so that both the customer's goal of a vacation home and the wife's goal of a European vacation are included in the merged timeline, the date for purchasing the vacation home needs to move to a date further out in the future, as shown by goal event of purchasing a vacation home 616. In addition, retirement for the customer and his wife are also moved further out in the future, as shown by the goal event of retire 618. For this example, the financial story module 108 makes adjustments based on keeping the wife's goal event of the European vacation 614 at the same time in timeline 606 as in timeline 604. The example timelines 602 and 604 only show a subset of possible events for the customer and his wife. Other events are possible.

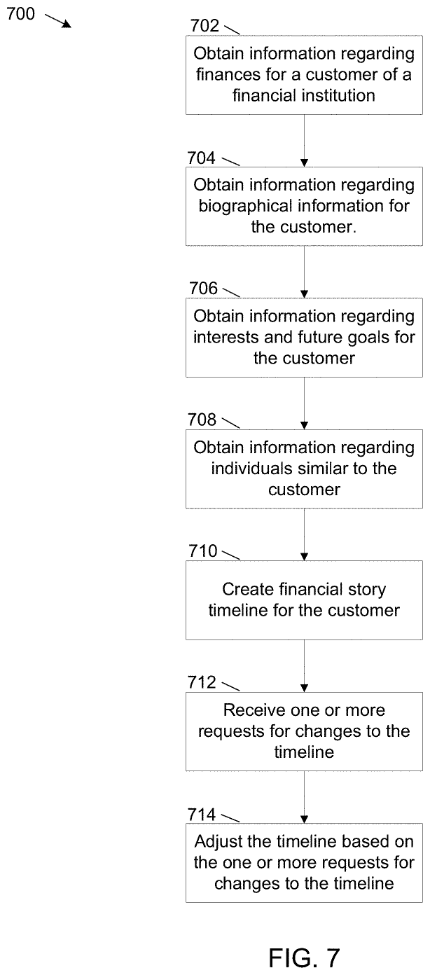

FIG. 7 shows a flowchart of an example method 700 for creating an interactive timeline for a financial life story. The method 700 can be implemented on a server computer of a financial institution, for example on financial institution server computer 106. The timeline can be rendered on an electronic computing device of a customer of the financial institution, for example on customer electronic computing device 102, when the customer logs in to a customer account on financial institution server computer 106.

At operation 702, information is obtained at financial institution server computer 106 regarding finances of the customer. When the customer has one or more accounts at the financial institution, the information regarding the finances of the customer can be obtained from the one or more accounts of the customer.

At operation 704, biographical information regarding the customer is obtained at financial institution server computer 106. The biographical information can be obtained from a personal profile of the customer. The personal profile is typically created when the customer opens the one or more accounts at the financial institution and can be updated periodically. The biographical information can include such items as the name, address and age of the customer, the customer's educational background, the customer's current employer and salary, the customer's employment history, information regarding the customer's family including names and ages of the customer's spouse and children and other information.

At operation 706, information is obtained at financial institution server computer 106 regarding interests and future goals of the customer. The information regarding the interests and future goals of the customer can be obtained from the personal profile and other sources.

At operation 708, information can be obtained at financial institution server computer 106 regarding individuals similar to the customer. The information regarding individuals similar to the customer can be obtained from a database of other customers of the financial institution. The database can store personal profiles of these other customers and transaction and event histories for these customers. Using information from the personal profiles of these other customers, the financial institution can identify customers that have similar educational backgrounds and similar socioeconomic backgrounds to the customer. The financial institution can then identify life events for these other customers and project the life events onto the timeline for the customer. For example, when a determination is made that many of these other customers start saving for college for their children at a certain age or at a certain point in their marriage, the financial institution can suggest a similar goal at a similar point in time on the timeline for the customer.

At operation 710, a financial story timeline is created for the customer at financial institution server computer 106. The financial story timeline, similar to timeline 200 from FIG. 2, is created based on the information gathered about the customer from operations 702-708. The financial story timeline includes a plurality of life events for the customer. As shown in FIG. 2, some of the events have already occurred, some of the events are based on personal goals of the customer, some of the events correspond to actions that the customer plans to do and some of the events are projected based on events from the other customers of the financial institution that are similar to the customer.

At operation 712, one or more requests are received at financial institution server computer 106 from the customer for changes to the timeline. The requests are received from customer electronic computing device 102. The requests are a result of the interactive aspect of the timeline. The timeline can be rendered on the customer electronic computing device 102. The customer can drag and move events on the timeline and can add events to the timeline. Each adjustment to an event or addition to an event can comprise a request for a change to the timeline that can be sent to financial institution server computer 106 from customer electronic computing device 102.

At operation 714, the timeline is adjusted at financial institution server computer 106 based on the one more requests for changes to the timeline received from customer electronic computing device 102. The financial institution server computer 106 can adjust one or more events on the timeline based on the customer profile and heuristics. For example, if the customer adds an event, such a goal for a European vacation, the financial institution server computer 106 can determine that the customer cannot afford to purchase a vacation home when the customer initially hoped to purchase the vacation home. Therefore, the financial institution server computer 106 can determine to move an event corresponding to a purchase of the vacation home further out into the future, as shown by vacation home event 404 in FIG. 4.

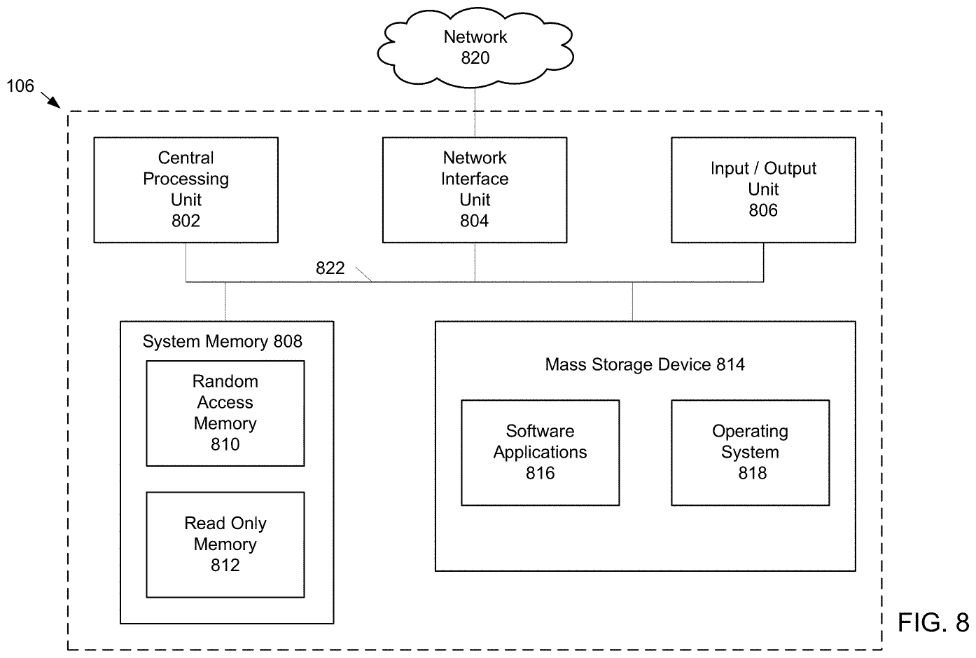

As illustrated in the example of FIG. 8, financial institution server computer 106 includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the financial institution server computer 106, such as during startup, is stored in the ROM 812. The financial institution server computer 106 further includes a mass storage device 814. The mass storage device 814 is able to store software instructions and data. Some or all of the components of the financial institution server computer 106 can also be included in customer electronic computing device 102.

The mass storage device 814 is connected to the CPU 802 through a mass storage controller (not shown) connected to the system bus 822. The mass storage device 814 and its associated computer-readable data storage media provide non-volatile, non-transitory storage for the financial institution server computer 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 106.

According to various embodiments of the invention, the financial institution server computer 106 may operate in a networked environment using logical connections to remote network devices through the network 820, such as a wireless network, the Internet, or another type of network. The financial institution server computer 106 may connect to the network 820 through a network interface unit 804 connected to the system bus 822. It should be appreciated that the network interface unit 804 may also be utilized to connect to other types of networks and remote computing systems. The financial institution server computer 106 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the financial institution server computer 106 can store software instructions and data. The software instructions include an operating system 818 suitable for controlling the operation of the financial institution server computer 106. The mass storage device 814 and/or the RAM 810 also store software instructions, that when executed by the CPU 802, cause the financial institution server computer 106 to provide the functionality of the financial institution server computer 106 discussed in this document. For example, the mass storage device 814 and/or the RAM 810 can store software instructions that, when executed by the CPU 802, cause the financial institution server computer 106 to display received data on the display screen of the financial institution server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for creating a financial story for an individual, the method comprising:
on the electronic computing device, receiving first information regarding finances for the individual;
obtaining second information comprising biographical information for the individual;
obtaining third information regarding future goals for the individual;
using the first information, the second information and the third information to create the financial story for the individual, the financial story comprising a first timeline that shows past and future life and financial events for the individual, including a first main branch showing the first timeline with past and future life and financial events;
creating a first separate branch of the first timeline to show an impact to the first timeline of a first possible future life or financial event, the first separate branch of the first timeline showing how a first date for an existing timeline event is impacted by the first possible future life or financial event;
receiving a second timeline, the second timeline having a second main branch and a second separate branch of the second timeline to show an impact to the second timeline of a second possible future life or financial event, the separate second branch of the second timeline showing how a second date for an existing timeline event is impacted by the second possible future life or financial event, wherein the second possible future life or financial event is different than the first possible future life or financial event; and
combining the first main branch comprising the first separate branch, and the second main branch comprising the second separate branch to create a merged timeline, wherein the merged timeline shows whether dates of the first separate branch are combinable with dates of the second separate branch;
wherein, on the merged timeline, automatically moving a date of the second possible future life or financial event on the merged timeline when the date of the second possible future life or financial event is incompatible with a date of the future life and financial events of the first timeline;
wherein at least some first possible future life and financial events for the individual on the first timeline are automatically generated using heuristics, the heuristics identifying life and financial events at timeline points for people of a similar background to the individual;
wherein at least some of the first possible future life and financial events for the individual are selected from a toolbar and dragged to the first timeline on a user interface by the individual; and
wherein the first timeline includes at least some identified life and financial events at the timeline points based on the heuristics.

2. The method of claim 1, wherein one or more aspects of obtaining the first information, the second information, the third information, and creating the first timeline are automated.

3-4. (canceled)

5. The method of claim 1, wherein at least one of the first timeline, the second timeline, and the merged timeline is interactive.

6. The method of claim 5, further comprising permitting the individual to manually adjust events on the first timeline and to manually add events.

7. The method of claim 6, further comprising automatically making adjustments to existing events on the first timeline based on the manually adjusted events and manually added events.

8. The method of claim 7, wherein the adjustments include one or more of removing one or more existing events from the first timeline or changing a time that an existing event is projected to occur.

9. The method of claim 1, further comprising automatically making adjustments to the first timeline based on an impact of one or more future decisions.

10-11. (canceled)

12. The method of claim 1, further comprising:
receiving a selection of a specific point on the first timeline; and
calculating a financial status of the individual at the specific point on the first timeline.

13. An electronic computing device comprising:
a processing unit; and
system memory, the system memory including instructions which, when executed by the processing unit, cause the electronic computing device to:
obtain first information regarding finances for an individual;
obtain second information comprising biographical information for the individual;
obtain third information regarding future goals for the individual;
obtain fourth information regarding financial transactions and life events for one or more additional individuals similar to the individual; and
use the first information, the second information, the third information and the fourth information to create an interactive first timeline for the individual, the interactive first timeline showing past and future life and financial events for the individual, the interactive first timeline for the individual including:
a main branch showing the interactive first timeline with the past and future life and financial events; and
a first separate branch showing how a date for the interactive first timeline is impacted by a first possible future life or financial event for the individual,
obtain a second timeline, the second timeline having the main branch and a second separate branch showing how the date for the interactive second timeline is impacted by a second possible future life or financial event for the individual, wherein the second possible future life or financial event is different than the first possible future life or financial event;
combine the main branch comprising the first separate branch, and the second timeline comprising the second separate branch to create a merged timeline, wherein the merged timeline shows whether dates of the first separate branch are combinable with dates of the second separate branch;
wherein, on the merged timeline, automatically move a date of the second possible future life or financial events on the merged timeline when the date of the second possible future life or financial event is incompatible with a date of the future life and financial event of the first timeline;
wherein at least some of the future life and financial events for the individual on the first timeline are automatically generated using heuristics, the heuristics identifying life and financial events at timeline points for people of a similar background to the individual, and wherein at least some of the future life and financial events for the individual are selected from a toolbar and dragged to the first timeline on a user interface by the individual; and
wherein the first timeline includes at least some identified life and financial events at the timeline points based on the heuristics.

14. The electronic computing device of claim 13, further comprising receiving one or more first adjustments to the first timeline, the one or more first adjustments to the first timeline comprising at least one additional event or an adjustment of a first existing event.

15. The electronic computing device of claim 14, further comprising automatically making one or more second adjustments to at least one second existing event on the first timeline as a result of the one or more first adjustments to the first timeline.

16. (canceled)

17. The electronic computing device of claim 13, wherein the first separate branch of the first timeline can display how current decisions can impact the at least some of the future life and financial events for the individual.

18. (canceled)

19. The electronic computing device of claim 13, further comprising:
receiving a selection of a specific point on the first timeline; and
calculating a financial status of the individual at the specific point on the first timeline.

20. An electronic computing device comprising:
a processing unit; and
system memory, the system memory including instructions which, when executed by the processing unit, cause the electronic computing device to:
obtain first information regarding finances for an individual;
obtain second information comprising biographical information for the individual;
obtain third information regarding future goals for the individual;
obtain fourth information regarding financial transactions and life events for one or more additional individuals similar to the individual;
use the first information, the second information, the third information and the fourth information to create and display on a user interface, an interactive first timeline for the individual, the interactive first timeline showing first past and future life and financial events for the individual, the interactive first timeline for the individual including:
a main branch showing the interactive first timeline with the first past and future life and financial events; and
a separate first branch showing how a date for the interactive first timeline is impacted by a first possible future life or financial event for the individual;
receive a first request to add a first additional event to the interactive first timeline;
as a result of the first request:
add the first additional event to the interactive first timeline; and
adjust a time of one or more existing events based on the first additional event;
receive, at the user interface, a second request to adjust a position of an existing event on the interactive first timeline; and
as a result of the second request:
adjust the position of the existing event on the interactive first timeline; and
adjust the time of one or more existing events based on an adjustment of the position of the existing event,
obtain a second timeline, the second timeline having the main branch and a second separate branch showing how a date for the interactive second timeline is impacted by a second possible future life or financial event for the individual, wherein the second possible future life or financial event is different than the first possible future life or financial event;
combine the main branch comprising the first separate branch, and the second timeline comprising the second separate branch to create a merged timeline, wherein the merged timeline shows whether the dates of the first separate branch are combinable with the dates of the second separate branch;
wherein, on the merged timeline, automatically move a date of the second possible future life or financial event on the merged timeline when the date of the second possible future life or financial event is incompatible with a date of the future life and financial event of the first timeline;
wherein, at least some of the first possible future life and financial events are based on heuristics, the heuristics identifying life events at timeline points for one or more of the additional individuals similar to the individual; and
wherein the interactive first timeline includes at least some of the life events at the timeline points based on the heuristics.
